(19) United States
(12) Patent Application Publication
(10) Pub. No.: US 2012/0127876 A1
(43) Pub. Date: May 24, 2012

(54) Cell Edge Coverage Hole Detection in Cellular Wireless Networks

(75) Inventors: Rajaguru Mudiyanselage Mythri HUNUKUMBURE, Hillingdon (GB); Hui XIAO, West Drayton (GB); Luciano Pietro Giacomo SARPERI, Bern (CH)

(73) Assignee: FUJITSU LIMITED, Kawasaki-shi (JP)

(21) Appl. No.: 13/292,807

(22) Filed: Nov. 9, 2011

(30) Foreign Application Priority Data
Nov. 22, 2010 (GB) 1019671.5

(51) Int. Cl. H04W 84/00; H04W 24/00; H04W 64/00; H04L 12/26

(52) U.S. Cl. 370/252

(57) ABSTRACT

A cell edge coverage hole detection method for a cellular wireless communication system such as an LTE system. A coverage hole in a cell edge region will cause radio link failures, RLF, which are difficult to distinguish from those caused by handover issues. The method collects (S10) RLF reports along with related connectivity patterns and location reports, and identifies (S20) a drive route across a cell edge at which radio link failures are occurring. By correlating (S30) the measurement reports from users travelling in both directions along the route, it can be judged (S40) whether a pattern specific to a coverage hole can be identified, distinguishing coverage holes (S60) from radio link failure occurring as a result of handover failure (S50).

### CROSS REFERENCE TO RELATED APPLICATION

This application claims priority to United Kingdom Patent Application No. 1019671.5 filed on Nov. 22, 2010, the disclosure of which is expressly incorporated herein by reference in its entirety.

The present invention relates to cellular wireless communication systems, and more particularly to detection of coverage holes in such systems.

In current mobile systems such as CDMA or OFDMA based systems including 3GPP-LTE (LTE), WCDMA, and the WiMAX standards such as IEEE 802.16e-2005 and IEEE 802.16m, autonomous optimisation of the cellular network has become a major factor for operators as they look to reduce and even eliminate some of the burdensome costs associated with operating the network. With respect to the above mentioned technologies, one term applied to this type of network is a Self Organizing Network (SON). (Incidentally, in this specification, the terms “network” and “system” are used interchangeably except where a distinction is clear from the context).

In the early deployment stages of both LTE and WiMAX, for example, the subscriber count will be low thus making radio coverage the primary focus for operators as they dimension, plan, optimise and rollout their network. It is then normal practice, as subscriber count and demand gradually increase, that operators will shift their focus towards increasing capacity to the desired levels through additional radio planning and optimisation.

From early deployment to network maturity, operators spend a great deal of time and money maintaining key performance indicators (KPI's) through an optimisation process involving a number of radio planning engineers analytically evaluating drive test data collected from taking local measurements in an area of coverage problems and adjusting radio parameters in their planning/optimisation tools. These optimal parameters can then be exported to the appropriate network management entities within live networks responsible for holding and controlling network parameters such as, in LTE, the O&M (parameter holding entity) and EM entities (element management for base station control).

It would therefore be desirable to eliminate the above manual process, increasing the number of optimisations/parameter adjustments that are carried out autonomously/automatically (without human intervention) thus ultimately reducing operating expenditure (OPEX) of the network.

Self Organizing Networks (SON) is a promising solution to optimising the network performance while reducing the time and expense consumed by drive tests. The standardisation of SON features is a key part in Release 9 and Release 10 of the 3GPP LTE-A standards. Since coverage optimisation is a typical task for network optimisation, automated coverage hole detection (CHD), which is the prerequisite for coverage optimisation, has been acknowledged as a key feature of SON.

In cellular wireless systems, a coverage hole is an area in which the signal strength experienced by a user equipment (mobile station) is not sufficient to maintain basic connectivity, and there is no coverage from an alternative cell. Coverage holes can exist within a single cell, or in the vicinity of a border (or “cell edge”) between adjacent cells. At a cell edge, particularly if a user equipment is moving from one cell to an adjacent cell, a handover process is performed to attach the user equipment to a base station of an adjacent cell. However, handovers may fail for a number of reasons, as discussed below.

Coverage holes and failed handovers will potentially involve user equipments experiencing Radio Link Failure (RLF) in which downlink and/or uplink coverage fails. A RLF occurs due to degradation of the air interface during an ongoing voice or a data service where generally, the physical layer detects a radio link failure when it becomes unsynchronised for instance.

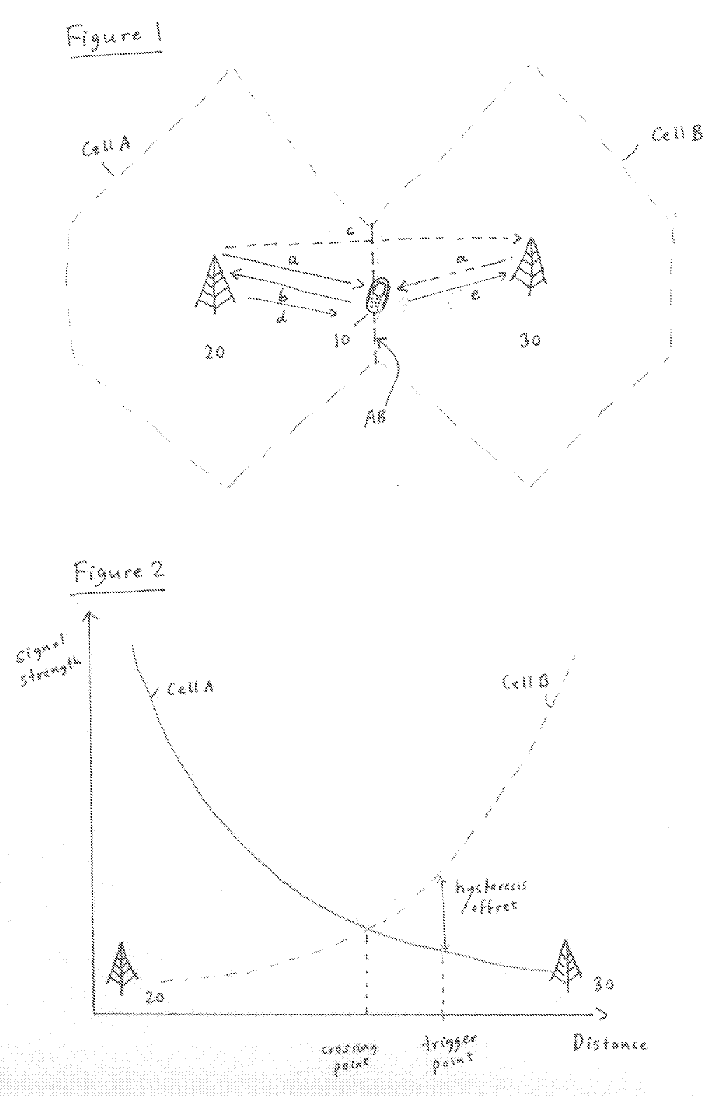

The present invention relates in particular to coverage holes near cell edges and to ways of distinguishing radio link failures due to coverage holes from radio link failures having other causes during handover. Before proceeding further, it may be helpful to briefly outline a typical handover process in a wireless communication system with respect to FIG. 1. It should be emphasised that the following outline is simplified from the protocols actually employed in LTE and other practical wireless communication systems. Moreover, various forms of handover may be possible within the same wireless communication network; the one presented here is a typical example, sometimes called a “backward” handover, in which the source and target base stations co-operate to avoid loss of data and (as far as possible) ensure continuity of service.

As a simplified example, FIG. 1 shows a network with two base stations (eNodeBs, in LTE terminology) 20 and 30, each providing a coverage area or cell for user equipments (referred to as UEs in LTE), Cell A and Cell B respectively. Hexagonal cells are shown here for simplicity, although an LTE system for example may divide each hexagonal area into three cells served by the same eNodeB, and as will be understood by those skilled in the art, the coverage areas are not actually hexagonal in practice, but somewhat amorphous in shape, variable and overlapping.

As schematically shown here, Cell A and Cell B join at a cell edge AB. We assume that a user equipment 10 is located in the vicinity of this cell edge, is currently being served (has connectivity) in Cell A by base station 20, but is moving gradually further towards base station 30. In an LTE context, serving base station 20 will be referred to as the “source eNodeB”, and base station 30 as a “target eNodeB”. As indicated by arrows “a” in FIG. 1, the user equipment can receive signals from both base stations 20 and 30. The nature of such signals is not important, but for example each base station may send a periodic reference signal which the user equipment detects in order to determine some measure of received signal strength.

FIG. 2 shows the received strength of these signals “a”, as experienced by the user equipment 10, as a function of distance from Cells A and B. As the user equipment moves along the distance axis in FIG. 2, that is, gradually further away from base station 20 and towards base station 30, it will experience a gradually reducing signal strength from Cell A (see the left-hand curve in FIG. 2) and a gradually strengthening signal from Cell B (the right-hand curve in FIG. 2). The respective curves of signal strength cross over at a crossing point marked on the distance axis. In other words, at this point the signal strength from each base station is equal, and user equipment 10 may have connectivity with either cell.

In other words, it would now be possible for the user equipment 10 to “handover” from Cell A to Cell B. However, this does not occur immediately upon reaching the crossing point. Rather, the user equipment waits until the signal strength received from Cell B as measured by the user equipment (below, “neighbour cell measurement”), exceeds that of Cell A (“serving cell measurement”) by a certain margin. One reason for this margin is to avoid too-frequent handovers (called “ping-pong” handovers), particularly where the radio conditions are fluctuating or user equipments move unpredictably relative to the base stations. Another reason is to prevent any interruption to applications having a high “Quality of Service” (QoS). That is, a wireless communication system such as LTE uses a so-called “hard” handover involving a brief loss of communication to the user equipment, which is undesirable in real-time applications such as streaming video.

The margin, referred to above, is depicted in FIG. 2 by the vertical arrow marked “hysteresis/offset”. The terms hysteresis and offset will be further explained below. There is another parameter, termed “timeToTrigger” in LTE systems, which is configurable to ensure the measurement report condition to be met for some duration. The example shown in FIG. 2 assumes that timeToTrigger is set as zero.

Assume now that the user equipment has moved closer to base station 30, such that its location corresponds to the point on the distance axis marked “trigger point”. At this point, the signal strength from Cell B exceeds that from Cell A by the required margin, which triggers (directly or indirectly) the handover to Cell B.

However, in LTE for example, the trigger point may not be the actual point of handover. Rather, the actual handover decision is taken by the base station 20 (eNodeB), guided by information from the user equipment 10. Thus, as indicated by arrow “b” in FIG. 1, the result of the user equipment reaching the trigger point is that it sends a measurement report to the base station 20 of Cell A, identifying the other base station 30 as one providing a sufficiently-higher signal strength. In other words the measurement report “b” identifies base station 30 as a target for handover. In response to this measurement report, base station 20 sends a handover (HO) request signal “c” (not necessarily wirelessly) to base station 30 to prepare it for the handover. Meanwhile, a HO command “d” is sent from the base station 20 to the user equipment; the timing of this command (and corresponding location of the user equipment) may be regarded as the handover decision point. For convenience, however, the trigger point shown in FIG. 2 may also be treated as a handover point.

The UE performs synchronisation to the target eNodeB 30 and accesses the target eNodeB via a RACH (Random Access CHannel) procedure. When the access to the target cell is complete, the UE issues a RRCConnectionReconfigurationComplete message to confirm the handover. This message is received by the target cell, Cell B (which has now become the source). This indicates the completion of the HO procedure from the radio access point of view. Such a successful handover allows the user equipment to continue communication with the minimum of interruption to service and minimum overhead on the network. Not every handover is successful, however; as discussed in more detail below, handover may be attempted too early or too late with respect to the target cell, causing RLF. These are called “(pure) handover issues” below. A failed handover may involve interruption of service, loss of data and/or the need to re-transmit data from or to the network.

Cell edge is a particularly difficult region for coverage hole detection. The result of a coverage hole will be radio link failure (RLF) and at cell edge, a common cause of RLF would be handover issues. Hence, coverage holes can easily be interpreted as handover failure at cell edge. Within this context, it is important to have robust methods which can distinguish between coverage holes and handover failure issues at cell edge,

According to a first aspect of the present invention, there is provided a method of detecting a coverage hole in a wireless communication network, the wireless communication network comprising respective base stations defining first and second cells which border one another at a cell edge, the base stations maintaining radio links with a plurality of user equipments, at least some of the user equipments crossing the cell edge in opposite directions along the same path, the method comprising: collecting reports indicative of radio link failure along with associated information transmitted from the user equipments to the base stations; filtering the collected reports based on said associated information to identify reports from user equipments crossing the cell edge in opposite directions along the same path; comparing the reports so identified to determine any pattern of radio link failures among the user equipments crossing the cell edge in opposite directions along the same path; and judging whether or not a coverage hole exists on the path based on the comparing.

In the above method, preferably, the associated information indicates a location of the user equipment at one or more timings before or after the radio link failure. The location is reported by a suitably-equipped user equipment, such as a Release 10 UE of LTE.

In the above method, preferably, the associated information indicates a connectivity sequence of the user equipment with base stations. Such a connectivity sequence can identify base stations with which a user equipment communicates before and after a radio link failure. It may therefore be based on information gathered by more than one base station.

The direction of crossing the cell edge is inferred from the location of the user equipment at successive timings, and/or from the connectivity sequence, depending on which information is available or most readily available.

In one embodiment of the method (in user reports associated with RLF), the filtering is based on location, and the comparing involves correlating the directions of crossing the cell edge and connectivity sequences associated with the reports so filtered. In other words, the reports originating from a given region are identified and of these, it is determined whether the connectivity sequences of user equipments crossing that region in opposite directions correlate or match up, such as to indicate presence of a coverage hole. Here, “correlate” implies, for example that user equipments in opposite directions undergo radio link failure at points in their connectivity sequence which indicate that the failure occurred at a similar location—such as prior to a handover in one direction and after handover in the opposite direction.

In another embodiment of the method, the filtering is based on direction of crossing the cell edge and connectivity sequence, and the comparing involves correlating the locations associated with the reports so filtered. In other words, candidates for “matching” RLFs in the opposite directions are first identified and these are examined to see whether they point to a particular location.

Location information may be gathered from a report transmitted separately from the report indicative of radio link failure. For example, a measurement report, sent by a user equipment to its serving base station to indicate its signal strength from the serving and neighbour base stations, may contain the information.

Preferably, the base stations send the reports indicative of radio link failure to another node in the network, in such a way that each report identifies the user equipment concerned and the base station sending it.

The reports indicative of radio link failure may include one or more of: reports generated in response to an initiated, but unsuccessful handover which include information indicative of a connectivity sequence or pattern associated with the unsuccessful handover; and reports generated shortly before or after a successful handover, which include information indicative of a connectivity sequence associated with the successful handover.

Any method as defined above may be applied to a LTE-based network in which the cells are provided by eNodeBs, and the reports indicative of radio link failure include at least one of an RLF report and an RRC Connection Reestablishment Request.

The method may be performed by a SON server which collects said reports and associated information from the eNodeBs.

According to a second aspect of the present invention, there is provided a wireless communication system arranged to perform any method as defined above.

According to a third aspect of the present invention, there is provided a SON server for use in the method. The SON server may be a general-purpose computer executing a SON algorithm written in software. However, the SON server need not be a single. distinct hardware entity but may be distributed among multiple nodes in the network, including possibly eNodeBs of an LTE network.

A further aspect is a base station such as an LTE eNodeB, adapted to supply reports for use in the above methods to another entity in a wireless communication network, such as a SON server.

In any of the above aspects, the various features may be implemented in hardware, or as software modules running on one or more processors.

The software may be provided in the form of a computer program product, such as a computer readable medium having stored thereon a program for carrying out any of the methods described herein. A computer program embodying the invention may be stored on a non-transitory computer-readable medium, or it could, for example, be in the form of a signal such as a downloadable data signal provided from an Internet website, or it could be in any other form.

Features and preferable features of any and all of the above aspects may be combined.

Reference is made, by way of example only, to the accompanying drawings in which:

FIG. 1 schematically illustrates handover between two cells A and B in a wireless communication network;

FIG. 2 is a graph of curves of received signal strength and distance for a UE near a cell edge between cells A and B;

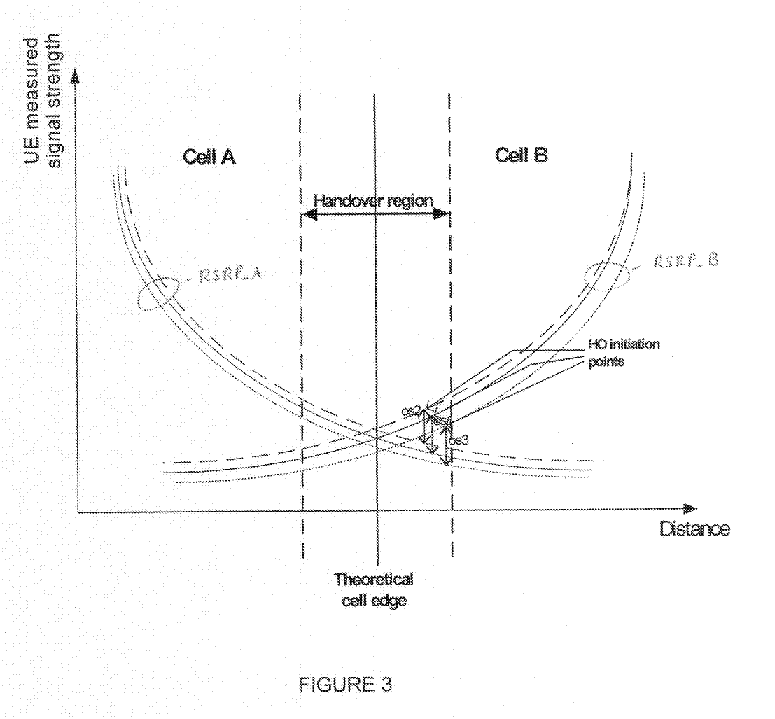

FIG. 3 is a graph similar to FIG. 2 but showing a range of signal strength curves for different UEs;

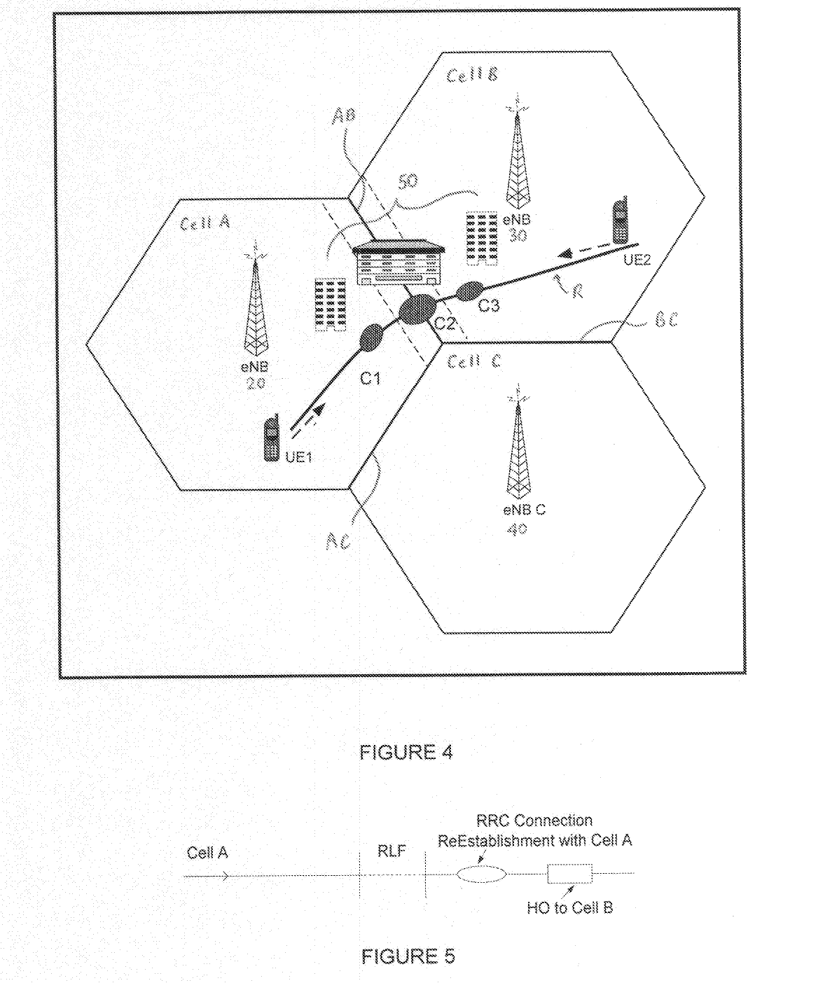

FIG. 4 shows three coverage hole scenarios near a cell edge between cells A and B;

FIG. 5 schematically shows an event sequence (connectivity pattern) for a UE passing through a coverage hole near a cell edge; and

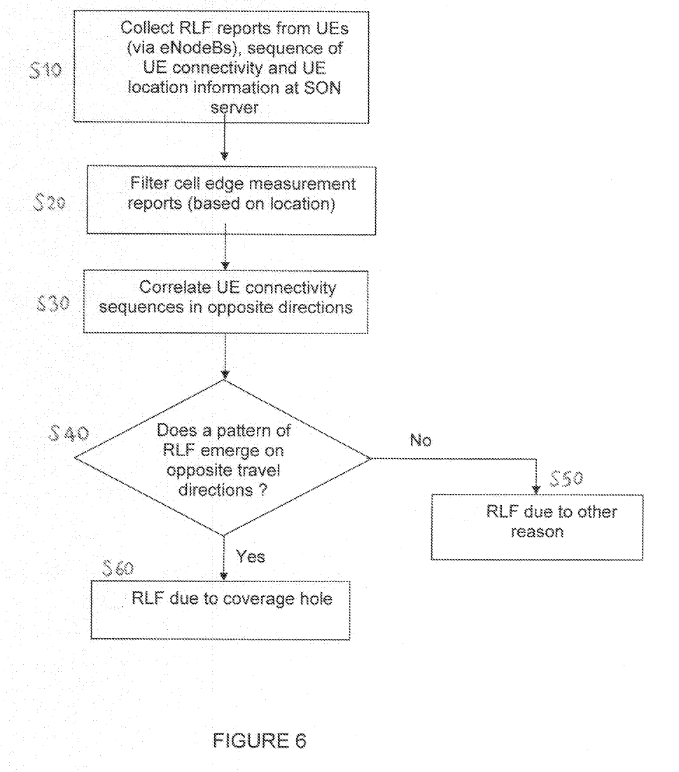

FIG. 6 is a flowchart of a method embodying the present invention.

In the following, the 3GPP LTE system is used as a background to present an embodiment of the present invention. However, it should be noted that LTE system serves purely as an example and the invention could be applied to any other wireless networks, where suitable information is available for performing the method.

Before explaining a method embodying the invention, some further background information will be given concerning handover execution at a cell edge.

In the LTE handover procedure, which in simplified terms has already been discussed with respect to FIGS. 1 and 2, the source eNodeB configures the measurement procedures for a UE with measurement control messages. These messages include specific thresholds (including offsets) in signal strength that should be fulfilled for the UE to provide a measurement report (message “b” in FIG. 1). Once the reporting conditions are fulfilled, the UE transmits measurement reports to the source eNodeB. The source eNodeB will initiate the handover process by sending the HO request to a target eNodeB identified in the measurement reports.

A common trigger for measurement reports to be transmitted to the source eNodeB is a so-called A3 event, which is satisfied when the neighbour cell measurement plus cell and frequency specific offsets minus a hysteresis becomes larger than the serving cell measurement plus cell and frequency specific offsets plus a user specific offset. The user specific offsets help to differentiate the service quality provided to each user. For example, a UE requiring a higher QoS would have higher offsets to ensure that it does not suffer from ping-pong effects at handover. The hysteresis value is also changeable per specific user.

Meanwhile, the measured signal strengths for two UEs in a similar location will not be identical. The RSRP (Reference Signal Received Power) is an average signal strength measurement and it will vary due to variations in the instantaneous measurements and measurement error. RSRP is an absolute signal power measurement in dBm (i.e. absolute) units. An alternative is RSRQ, which is Reference Signal Received Quality; this is a relative power measurement (or signal quality measurement) considering the interference from neighbour cells as well. This measurement is done in dB (i.e. relative) units. Accordingly, in this specification, the expression “signal strength” covers both absolute and relative measures of signal strength.

Due to the above effects, the HO decision point on the relative signal strength graph will vary for individual UEs.

That is, as shown in FIG. 3, the measured signal strength curves (collectively denoted RSRP_A for Cell A and RSRP_B for Cell B) and the individual offset/hysteresis values, will vary for each UE; this will give a distribution of handover points for the UEs travelling from Cell A to Cell B. The user specific offsets and hysteresis are denoted by os1, os2 and os3 in FIG. 3. The scenario for UEs travelling in the opposite direction (in other words those UEs with a connectivity pattern from Cell B to Cell A) will be same. Hence there will be a collective handover region, as shown by the portion of the distance axis between dashed lines in FIG. 3.

When a RLF is repeatedly reported from a specific cell edge, it is normal for the eNodeBs to change the offset values to try and solve the RLF issue. If the RLF is due to a handover issue, changing the offsets (i.e. measurement configuration) should solve the handover problem. Initially the occurrence of RLF events may go up due to wrong parameter settings, but as the tuning becomes more accurate, the RLF events should become negligible. Conversely, if a constant residue of RLF events is observed for the whole range of possible offset (and hysteresis) values, and in both travel directions, then it could be positively detected that a coverage hole exists in that particular cell edge. Changing the hysteresis and/or offsets in this way is referred to below as “tuning”.

The method of the invention particularly concerns cell edge region coverage hole detection. By “cell edge”, as already mentioned, is meant the region where the UE can measure signals from more than one eNodeB (i.e. from its source or serving eNodeB and one or more neighbour eNodeBs). It is assumed that UEs are crossing the cell edge along opposite paths (below called “drive routes”), for example in vehicles travelling in both directions on a highway. An important feature of the method is to accumulate radio link failure reports for a given location, filter them as per the travel direction of the UE (the travel direction can be identified by extracting location information of successive measurement reports, or by connectivity pattern as explained later) and correlate the sequence of events in the opposing directions. If specific patterns of UE connectivity (to eNodeBs) leading to RLF emerge from this correlation, a coverage hole can be detected with an increased level of confidence.

When a UE enters the cell edge region, it is likely to regularly provide measurement reports to its serving eNodeB. In LTE Release 9 standards (see for example 3GPP Technical Specification TS 36.331, “Radio Resource Control Protocol Specification”, v9.2.0, March 2010 which is hereby incorporated by reference), five events are documented when the UE will provide measurements to the serving eNodeB. As already mentioned, when a neighbour cell signal strength rises by an offset+hysteresis above the serving cell signal strength, the serving cell selects that neighbour as a target cell for handover and initiates handover procedures. The measurements can be configured for SON purposes as well. When a UE suffers RLF, the RLF report will be made to the eNodeB to which the UE connects after the RLF event. The requirement is to identify RLFs which occur as a result of coverage holes and distinguish them from handover failures. The measurement and RLF reports are accumulated and processed at a SON server (see below), in order to identify the coverage holes.

Consider the macro cellular layout as shown in FIG. 4, with three hexagonal cells, Cell A, Cell B and Cell C, each with a respective base station 20, 30 and 40. Users carrying user equipments UE1 and UE2 travel along a drive route and in doing so, cross in opposite directions the cell edge AB between Cell A and Cell B. The drive route running across the cell edge can be, for example, along a road or railway R. Of course, there may be several distinct drive routes across the same cell edge and/or across other cell edges of the same cell with other cells: for example cell edge AC between Cell A and Cell C. There are tall buildings 50 in the vicinity which block radio signals and lead to a coverage hole C1, C2 or C3, each of which is discussed below. Although these coverage holes are described here as alternatives for the purposes of explaining the present invention, it would be possible for more than one such coverage hole to exist at the same time.

It can be assumed that the vast majority of handovers in this cell layout will occur along these drive routes. The method of the invention involves the correlation of measurements and RLF (for example through RLF reports) on both directions of the drive route. This process is assisted with accurate location estimates, which will be available under release 10 of LTE-A standards, with Minimization of Drive Tests (MDT) specifications (see 3GPP Technical Specification TS 37.320, “Radio Measurement Collection for Minimization of Drive Tests; Overall description”, v0.3.1, April 2010, hereby incorporated by reference). Location information is used to assign a particular RLF event to a specific drive route, as there can be multiple drive routes and possibly multiple coverage holes across a given cell edge.

The location information may be a part of the measurement reports routinely generated. For example it can be a part of signal strength reports the UE generates at cell edge. The location report at the exact point of RLF may not be available, but from the location reports before and after the RLF, the user route and direction can be identified.

There can be an asymmetry of numbers of UEs travelling in the two directions on a drive route, especially during the busy hours. In this case the RLF information will also be asymmetrical. To deal with this, the RLF reports can be normalised with respect to the sample size of the reports, prior to correlating the results in both directions to identify any coverage holes.

It should be noted that RLF reports are only one mode of identifying radio link failure. If RLF reports are not available, RRC Connection Reestablishment Requests or other methods can be used to identify radio link failure. When a UE suffers RLF, it is able to re-connect to an eNodeB without going into idle mode due to its mobility. This is a reasonable assumption for fast moving users on drive routes as the LTE specifications allow up to 30s for the UE to attempt connection re-establishment (through the so-called T311 timer, details of which can be found for example in the document “LTE: The UMTS Long Term Evolution”, by S Sesia et al, section 3.2.3, Wiley Publishers, 2009, which is hereby incorporated by reference).

The handover region in the cell edge AB is marked with the dotted lines. This is a region rather than a single crossover line, as there is a hysteresis value associated with handover as already mentioned. The hysteresis ensures that there are no ping-pong (repeated) handovers at the cell edge. Consequently, the handover usually happens inside the target cell, when the signal strength of the target cell is an offset+hysteresis better than the source cell.

The three possible coverage holes in the cell edge and the detection methodologies are discussed below.

### Coverage Hole Before HO Region

Suppose that the UE1 in FIG. 4 currently has a radio link with eNodeB 20 of Cell A. In this case Cell A is called the “serving cell” of the UE. Suppose also that, as a result of the obstruction of buildings 50 for example, a coverage hole exists to the Cell A side of the handover region in FIG. 4. This scenario is illustrated as C1 in FIG. 4. For the user moving AB, in other words from Cell A to Cell B (UE1 in FIG. 1), the coverage hole will occur before the HO process is commenced by the serving eNodeB 20. After the RLF, the UE will re-establish the connection with the serving eNodeB 20 of Cell A, or if the signal from eNodeB 30 is stronger it will connect to eNodeB 30 in neighbour Cell B. If the UE connects to eNodeB 20, it soon enters the HO region, the HO process will be re-initiated and UE1 will subsequently connect to eNodeB 30. With accurate location information (which will be available under MDT in Release 10 of LTE, see the TS 37.320 reference cited above) the eNodeB 20 will be able to log the RLF event occurring just before the HO region.

FIG. 5 shows an example “event sequence” in this scenario, in which the horizontal axis represents distance (or alternatively time, assuming constant velocity of the UE). Corresponding event sequences will exist for the other scenarios to be described later.

As shown in FIG. 5, the event sequence involves UE1, initially in communication with Cell A, losing its radio link with the corresponding eNodeB 20 (perhaps due to a coverage hole) and then performing an RRC Connection ReEstablishment procedure with Cell A, shortly after which the eNodeB 20 of Cell A hands the UE over to eNodeB 30 of neighbour Cell B as already mentioned. Thus, the event sequence is (or includes) a “connectivity pattern” or “connectivity sequence” of the UE. This connectivity pattern (Cell A->RLF->Cell A->Cell B) may be used to identify the direction of travel of the UE, particularly if the source eNodeB 20 decides to hand over after a single measurement. Alternatively, successive location reports may be used to determine direction of travel of the UE.

In the normal mode of operation, eNodeB 20 will interpret that the RLF is caused by too late handover or in some cases too early handover, and try to remedy it (for other UEs on the same route) by changing the handover point.

This is done by “tuning” the HO parameters (hysteresis and/or offsets) as already mentioned. In the present scenario, however, this will not solve the issue as the eNodeB 30 is too far away to maintain sufficient signal strength to support the UE at the RLF location. (If the handover solves the problem, we do not have a coverage hole issue). Hence the RLF problem will persist.

A method embodying the invention considers also the connectivity pattern for UEs moving in the reverse direction of the road (for example UE2 in FIG. 4) and correlate the events occurring in the two opposite directions. If the coverage hole is at C1, UE2 will conduct successful handover to eNodeB 20 from eNodeB 30, and then suffer RLF. This pattern leading to RLF can be correlated with the RLF pattern in the reverse direction (UE1, AB), where RLF happens before handover. With location information, it can be estimated that these events are happening on the same route. (Location information at the point of RLF may not get transmitted back to the eNodeB, but locations before and after the RLF event can be estimated). This is done by the eNodeBs collecting reports received by them and feeding the information up to a SON server in the network, which collects, filters and matches the reports as explained below.

This process is performed not just for UE1 and UE2, but for many UEs and for various settings of HO parameters as the eNodeBs attempt to solve the handover issues. Thus, the coverage hole detector will not rely on a single set of RLF reports (or other RLF indicators), but will gather reports over time and look at the patterns, making use of the “tuning” of HO parameters performed by eNodeBs in their normal mode of operation. When the RLF reports in the two directions are compared, a clear pattern—in other words a correlation—will emerge if a coverage hole exists at C1. This correlation enables accurate detection of a coverage hole.

Coverage Hole within the HO Region

This scenario is illustrated as C2 in FIG. 4. In this case, the assumption is that both the serving eNodeB 20 and the target eNodeB 30 are blocked by the obstruction due to tall buildings 50, leading to coverage hole C2. (If only one eNodeB is blocked, the coverage hole can be easily compensated by re-tuning the handover parameters). In the case of UE1 moving into this coverage hole, the RLF will occur soon after the HO process is initiated. The UE may have submitted measurements reports, but eNodeB 20 may not have issued the final HO command. In this situation, UE1 will re-connect with the neighbour eNodeB 30.

Considering now a user travelling along the same drive route but in the reverse direction, UE2 will suffer RLF soon after the handover process is initiated by the serving eNodeB 30. UE2 will re-connect with eNodeB 20 after the RLF. Because both eNodeBs are affected by the coverage hole, re-tuning the handover parameters will not solve the RLF issue in either direction. By correlating the RLF reports in both directions, the coverage hole can be detected. Without this bi-directional RLF event correlation, this event would clearly pass as a handover failure.

Coverage Hole after HO Region

FIG. 4 shows a coverage hole C3 located toward the Cell B side of the handover region around cell edge AB. For UE1 (Cell AB), the RLF will occur after successful handover to eNodeB 30 from eNodeB 20. This is the same pattern of events which UE2 will see in the case of a coverage hole at C1. Similarly for UE2, the RLF at C3 will occur just before handover and it will re-connect to serving eNodeB 30 or the target eNodeB 20. This is the same pattern of events as would be experienced by UE1 when the coverage hole is at C1. Consequently, when a set of RLF reports in both directions is correlated, the coverage hole at C3 can be identified.

A general methodology for a detection algorithm applying the present invention is given in the flow chart of FIG. 6. In summary, the algorithm collects (S10) RLF reports along with related connectivity patterns and location reports, and identifies (S20) a drive route across a cell edge at which radio link failures are occurring. By correlating (S30) the measurement reports from users travelling in both directions along the route, it can be judged (S40) whether a pattern specific to a coverage hole can be identified, distinguishing coverage holes (S60) from radio link failure occurring as a result of handover failure (S50).

In Step S10, a SON server gathers information from the eNodeBs in the network. RLF reports are collected along with associated connectivity and location reports. The availability of location reports will depend on the event sequence involved and on standardisation work for LTE Release 9 and 10 which has yet to be completed. For example for the case of a coverage hole like C1 in FIG. 4, the event sequence shown in FIG. 5 is applicable, but the location reports can be issued anywhere in the solid horizontal line, both before and after the RLF. However, it is expected that location reports will be issued independently of, and at distinct timings from, RLF reports. For example, location reporting may be combined with measurement reports of a UE's received signal strength from serving and neighbour eNodeBs. In any case, the reports will include some form of ID to identify the specific UE involved, for example by using a radio network identifier assigned to the UE and contained (explicitly, or implied) in reports issued by the UE.

The SON server should collect reports from more than one eNodeB, and identifying information of eNodeBs, contained in the reports, will allow specific UE reports to be tracked back to the eNodeB from which they were collected. Typically, correlation of reports from UEs travelling in opposite directions along a certain route will require information to be collected from two eNodeBs. There may be cases at cell edges (rather corners) where three or more cells meet, so that the SON server has to rely on reports from more than two eNodeBs. This step may be continued for a time period needed to gather a statistically meaningful data set.

Step S20 involves the SON server processing or “filtering” the gathered information from step S10. This identifies, for a specific cell edge, a specific route (amongst possibly many) in the cell edge at which RLFs are occurring. Also, direction information should be derived here, to be used in the next step. Connectivity reports (in other words reports from UEs on which eNodeB a UE is connected to, and whether RLF has occurred) and/or location reports, may be used by the SON server to determine the direction of travel of a given UE. One or several such routes and cell edges may be considered in this step.

In step S30 the filtered reports, relating to UEs travelling the same drive route in different directions, are correlated (compared). From this, step S40 judges whether a (positive) correlation exists—in other words whether reports from UEs travelling in one direction along the drive route are matched by reports from UEs in the opposite direction. In the case of a C1-type coverage hole for example, a correlation (match) would exist where there are reports of RLF prior to handover for users travelling along drive route R from Cell AB along with reports of RLF after handover for users travelling along the same drive route in the opposite direction. It can be assumed that collection of RLF reports over a sufficient time period will have RLF reports with different HO settings reporting the RLF at the same location. This in itself is a strong indication of coverage hole, and when correlated in both directions, if a pattern emerges it significantly improves the confidence of being a coverage hole. Here, the strength of the correlation may be taken into account in order to determine a level of confidence in the coverage hole inferred—for example by considering the proportion of such matching reports as a total of all RLF reports for that drive route or that cell edge.

If the result of S40 is that there is no clear pattern (S40, No) the conclusion (S50) is that the RLFs are due to some reason other than a coverage hole. On the other hand if a pattern is found to exist (with any desired conditions on the degree or strength of correlation) this is taken (S60) as indication of a coverage hole in a region defined by location reports before and after RLF.

As a variant of the above algorithm, S20 and S30 can be interchanged, i.e. step S20 may alternatively involve filtering RLF patterns which resemble travel in opposite directions and at step S30 then correlates the location information. If the location information points to a single location, a coverage hole can be detected.

A further variant of the algorithm will be to rely on the direction of travel (obtained from the connectivity pattern) rather than the exact connectivity pattern such as “from Cell A to Cell B” (in Step S30 above) to establish a coverage hole. This is beneficial if a coverage hole generates more than one connectivity pattern in a given direction. However, this requires very accurate location information.

An example will be at a cell corner (where 3 cells meet, if there is a drive route and a coverage hole. The route may be from Cell A to Cell C but Cell B is also adjacent. Then there will be connectivity patterns like A→C, A→B→C, A→C→B→C etc. Of course, only connectivity patterns involving RLF are of interest in the present invention.

It should be noted that RLF reports are only one mode of identifying radio link failure. If RLF reports are not available, RRC Connection Reestablishment Requests or other methods can be used to identify radio link failure.

To implement the above-mentioned method, some form of SON management functionality has to be incorporated into the network. Where this resides is unimportant for understanding the invention, but for convenience we may assume that there is a SON server attached to the network at a relatively high level. This will typically be a general-purpose computer executing a SON algorithm. Alternatively the SON functionality may be distributed among the eNodeBs (and/or among so-called Mobility Management Entities, MMEs, which control the eNodeBs) for example.

Having identified the presence of a coverage hole by the above method, the SON server may take some form of remedial action, for example by instructing eNodeBs to change their configuration in some way in an attempt to compensate, and/or by prompting a human supervisor to take action.

Various modifications are possible within the scope of the present invention.

Although the above description refers to detection of coverage holes, the present invention is broader than merely detecting coverage holes per se. For example, it may be that the existence of a coverage hole per se is already known, yet it may be desired to gauge its extent, or severity at a certain point in time. Thus, to generalise, what the present invention provides is not necessarily (or not just) detection of a coverage hole but information about a coverage hole.

Although the above detailed description has referred to an LTE wireless communication system as an example, this is not essential, and the same technique can be applied to any kind of system wherein location information is given from mobile stations and analysis of data from users travelling in opposite directions may be expected to yield information about coverage holes. In the claims, the term “user equipment” is intended to embrace any kind of portable subscriber station used in wireless communication system, including mobile stations normally denoted by MS in WiMAX and UE in LTE.

In the above description it has been assumed that UEs issue location reports at intervals, allowing a direction of travel of the UE to be inferred from successive location reports. However, the connectivity patterns of UEs (known to the SON server through the information collected from eNodeBs) may alternatively be used to find direction of travel. Furthermore, if a UE were to report its velocity as part of a report this would allow the direction of travel to be determined directly.

In the above embodiment it was stated that the location information may be a part of the measurement reports routinely generated in normal operation of the wireless communication system. However, it will also be possible to run the system in a special SON mode wherein UEs are required to send additional measurement reports for SON purposes, for example to allow more accurate location of UEs undergoing RLF. Such a mode of operation could be implemented periodically or as required, to avoid unnecessary power consumption of UEs.

As already mentioned normal eNodeB behaviour will tune the HO parameters if an RLF is repeated at a certain location. Also the HO parameters for each UE will be (slightly) different and this also gives a wide range of HO parameters in the RLF reports. However, if desired it would be possible for the SON server to instruct the eNodeBs to perform additional “tuning” for the purpose of coverage hole detection, for example by varying HO parameters in larger than normal steps to accentuate the differences between coverage hole and pure handover issues.

Thus, to summarise, an embodiment of the present invention relates to the SON feature of coverage hole detection in the cell edge region of a cellular network. A coverage hole in the cell edge region will have ambiguity with the radio link failure due to handover issues. The invention proposes to make use of the measurement reports from users travelling in both directions across a cell edge. By correlating user reports and their direction of travel, certain patterns specific to a coverage hole can be identified. This helps to reduce the ambiguity and distinguish coverage holes from radio link failure occurring as a result of handover failure.

Thus, embodiments of the present invention offer a solution to the coverage hole detection problem in a particularly difficult area, the cell edge. At cell edges, the coverage holes can readily be confused with handover issues. The present invention offers a robust method of identifying coverage holes through the use of bi-directional information from mobile users.

1. A method of detecting a coverage hole in a wireless communication network, the wireless communication network comprising respective base stations (20, 30) defining first and second cells (Cell A, Cell B) which border one another at a cell edge (AB), the base stations maintaining radio links with a plurality of user equipments (UE1, UE2), at least some of the user equipments crossing the cell edge in opposite directions along the same path, the method comprising:
collecting reports indicative of radio link failure along with associated information transmitted from the user equipments (UE1, UE2) to the base stations (20, 30, 40);
filtering the collected reports based on said associated information to identify reports from user equipments (UE1, UE2) crossing the cell edge (AB) in opposite directions along the same path (R);
comparing the reports so identified to determine any pattern of radio link failures among the user equipments (UE1, UE2) crossing the cell edge (AB) in opposite directions along the same path; and
judging whether or not a coverage hole (C1, C2, C3) exists on the path based on the comparing.

2. The method according to claim 1 wherein the associated information indicates a location of the user equipment at one or more timings before or after the radio link failure.

3. The method according to claim 1 wherein the associated information indicates a connectivity sequence of the user equipment with base stations.

4. The method according to claim 2 wherein the direction of crossing the cell edge (AB) is inferred from the location of the user equipment at successive timings.

5. The method according to claim 3 wherein the direction of crossing the cell edge (AB) is inferred from the connectivity sequence.

6. The method according to claim 2 wherein the filtering is based on location, and the comparing involves correlating the directions of crossing the cell edge (AB) and connectivity sequences associated with the reports so filtered.

7. The method according to claim 2 wherein the filtering is based on direction of crossing the cell edge (AB) and connectivity sequence, and the comparing involves correlating the locations associated with the reports so filtered.

8. The method according to claim 2 wherein the location of the user equipment is included in a report transmitted separately from the report indicative of radio link failure.

9. The method according to claim 1 wherein the base stations (20, 30, 40) send the reports indicative of radio link failure to another node in the network, in such a way that each report identifies the user equipment concerned and the base station sending it.

10. The method according to claim 1 wherein the reports indicative of radio link failure include one or more of: reports generated in response to an initiated, but unsuccessful handover which include information indicative of a connectivity sequence associated with the unsuccessful handover; and reports generated shortly before or after a successful handover, which include information indicative of a connectivity sequence associated with the successful handover.

11. The method according to claim 1, applied to a LTE-based network in which the cells are provided by eNodeBs, and the reports indicative of radio link failure include at least one of an RLF report and an RRC Connection Reestablishment Request.

12. The method according to claim 11 wherein the method is performed by a SON server which collects said reports and associated information from the eNodeBs.

13. A wireless communication system arranged to perform the method according to claim 1.

14. A SON server for use in the method according to claim 11.

15. Software which, when executed by a computer, configures the computer to provide the SON server according to claim 14.
